(19) United States
(12) Patent Application Publication
(10) Pub. No.: US 2012/0154315 A1
(43) Pub. Date: Jun. 21, 2012

(54) INPUT APPARATUS

(75) Inventor: Tomotake Aono, Tokyo (JP)

(73) Assignee: KYOCERA CORPORATION, Kyoto (JP)

(21) Appl. No.: 13/392,858

(22) PCT Filed: Aug. 26, 2010
(86) PCT No.: PCT/JP2010/005276

§ 371 Date: Feb. 27, 2012

(30) Foreign Application Priority Data
Aug. 27, 2009 (JP) 2009-196279

(51) Int. Cl. G06F 3/041

(52) U.S. Cl. 345/173

(57) ABSTRACT

An input apparatus, which provides feedback to a user through a tactile sensation in response to a push operation and a slide operation to a touch sensor by the user, is provided. The control unit controls drive of a tactile sensation providing unit when the touch object slides on a touch face such that a tactile sensation of sliding is provided to a touch object and controls drive of the tactile sensation providing unit when a load detection unit detects a pressure load changing from a state failing to satisfy a predetermined standard load to a state satisfying it such that a tactile sensation of pushing, different from the tactile sensation of sliding, is provided to the touch object.

### CROSS REFERENCE TO RELATED APPLICATION

This application claims priority to and the benefit of Japanese Patent Application No. 2009-196279 (filed on Aug. 27, 2009), the entire contents of which are incorporated herein by reference.

### TECHNICAL FIELD

The present invention relates to an input apparatus, and more particularly, to an input apparatus having a touch sensor.

### BACKGROUND ART

Input apparatus of mobile terminals such as mobile phones and gaming machines, for example, used by users to operate the terminals have been developed in a variety of manners according to functions and usages of each of the terminals Lately, especially the input apparatus having touch panels have been increased. Since the input apparatus having the touch panel receives an input in the form of a user's contact (touch) at fingertip and the like to an object such as a button and an icon displayed on the display unit, the user can operate it highly intuitively. That is, the user operates the input apparatus by, at the fingertip and the like, touching the input object displayed on a screen following a guide displayed on the screen of the touch panel. Accordingly, the user can operate the terminal very easily by intuitive operations following the guide displayed on the screen, which offers an additional effect to reduce incorrect operations as a result.

There are known a variety of types of those touch panels, such as a resistive film type, a capacitive type, an optical type and the like. However, the touch panels of these types are not physically displaced in response to a touch input. As a result, being unable to obtain feedback similar to that of a push-button switch in response to the touch input, the operator is likely to operate erroneously by pressing the same spot multiple times, which may be stressful for the operator.

As a method to prevent such erroneous inputs, there is known a feedback method which, upon detection of the touch input by the user, vibrates the touch panel to generate vibration at user's fingertip (for example, see Patent Document 1).

Since the technique disclosed in Patent Document 1 set forth above allows the user to perceive, through vibration of the touch panel, that the touch input to the touch panel by the user is detected, the user is prevented from erroneously touching the same spot multiple times.

In addition, Patent Document 2 discloses a technique to provide vibration to the user in response to a sliding operation on the touch panel by the user.

Since the technique disclosed in Patent Document 2 set forth above allows the user to perceive, through vibration of the touch panel, that the sliding operation to the touch panel is received, the user is prevented from erroneously performing the sliding operation at the same position multiple times.

### RELATED ART DOCUMENTS

### Patent Documents

Patent Document 1: Japanese Patent Laid-Open No. 2003-288158

Patent Document 2: Japanese Patent Laid-Open No. 2005-62043

### SUMMARY OF INVENTION

### Technical Problem

However, although the techniques described above provide feedback through vibration in response to the touch operation or the sliding operation (slide operation) by the user, no mention is made of a push operation in which the user presses the touch panel (touch sensor) by these techniques.

An object of the present invention is to provide the feedback to the user through a tactile sensation in response to the push operation and the slide operation to the touch sensor by the user.

### Solution to Problem

In order to solve the above problem, an input apparatus according to a first invention includes: a touch sensor configured to detect a touch input; a tactile sensation providing unit configured to vibrate a touch face of the touch sensor; a load detection unit configured to detect a pressure load on the touch face; and a control unit configured to control drive of the tactile sensation providing unit such that a tactile sensation is provided to a touch object touching the touch face, wherein the control unit, when the touch object is sliding on the touch face, controls drive of the tactile sensation providing unit such that a tactile sensation of sliding is provided to the touch object and, when the load detection unit detects the pressure load changing from a state failing to satisfy a predetermined standard load to a state satisfying the predetermined standard load, controls drive of the tactile sensation providing unit such that a tactile sensation of pushing, different from the tactile sensation of sliding, is provided to the touch object.

The input apparatus according to a second invention, wherein the control unit controls drive of the tactile sensation providing unit such that the tactile sensation of pushing is provided to the touch object when the touch object is not sliding on the touch face.

The input apparatus according to a third invention, wherein the control unit controls drive of the tactile sensation providing unit such that the tactile sensation of sliding is provided to the touch object when the pressure load detected by the load detection unit satisfies a standard load lower than the predetermined standard load.

The input apparatus according to a fourth invention, wherein, when the touch object stops sliding while the control unit is controlling drive of the tactile sensation providing unit such that the tactile sensation of sliding is provided to the touch object and the load detection unit detects application of a predetermined pressure load in addition to a standard, which is the pressure load detected by the load detection unit when the touch object stops sliding, the control unit controls drive of the tactile sensation providing unit such that the tactile sensation of pushing is provided to the touch object.

The input apparatus according to a fifth invention, further includes a display unit configured to display an input object, wherein the touch sensor detects the touch input to the display unit, and the control unit controls drive of the tactile sensation providing unit when the touch input to an area, where the input object is not displayed, is detected, such that the tactile sensation of sliding is provided, and controls drive of the tactile sensation providing unit when the touch input to the input object is detected, such that the tactile sensation of pushing is provided.

### EFFECT OF THE INVENTION

According to the present invention, it is possible to provide feedback to a user through the tactile sensation in response to a push operation and a slide operation to the touch sensor by the user.

### BRIEF DESCRIPTION OF DRAWINGS

FIG. 1 is a functional block diagram illustrating a mobile phone according to embodiments of the present invention;

FIG. 2 is a flowchart for illustrating a process to provide a tactile sensation of sliding and a tactile sensation of pushing according to a first embodiment;

FIG. 3 illustrates diagrams illustrating provision of the tactile sensation of pushing according to the first embodiment;

FIG. 4 illustrates diagrams illustrating provision of the tactile sensation of sliding according to the first embodiment;

FIG. 5 is a flowchart for illustrating a process to provide the tactile sensation of sliding and the tactile sensation of pushing according to a second embodiment;

FIG. 6 illustrates diagrams illustrating provision of the tactile sensation of sliding according to the second embodiment;

FIG. 7 is a flowchart for illustrating a process to provide the tactile sensation of sliding and the tactile sensation of pushing according to a third embodiment;

FIG. 8 illustrates diagrams illustrating provision of the tactile sensation of sliding according to the third embodiment;

FIG. 9 is a diagram illustrating a process to provide the tactile sensation of sliding and the tactile sensation of pushing according to a fourth embodiment;

FIG. 10 is a diagram illustrating provision of the tactile sensation of pushing according to a fifth embodiment; and

FIG. 11 is a diagram illustrating provision of the tactile sensation of sliding according to the fifth embodiment.

### DESCRIPTION OF EMBODIMENTS

Embodiments of the present invention will be described with reference to the accompanying drawings, hereafter. In the following embodiments, a mobile phone is used as an example of mobile terminals having an input apparatus according to the present invention. However, the mobile terminal to which the input apparatus according to the present invention is applicable is not limited to the mobile phones but may be a variety of mobile electronic equipment having the input apparatus such as, PDAs, digital cameras, gaming machines and the like. In addition, the application of the present invention is not limited to the mobile terminals, but applicable to equipment having input apparatuses such as ATM machines, ticket vending machines at train stations and the like.

### First Embodiment

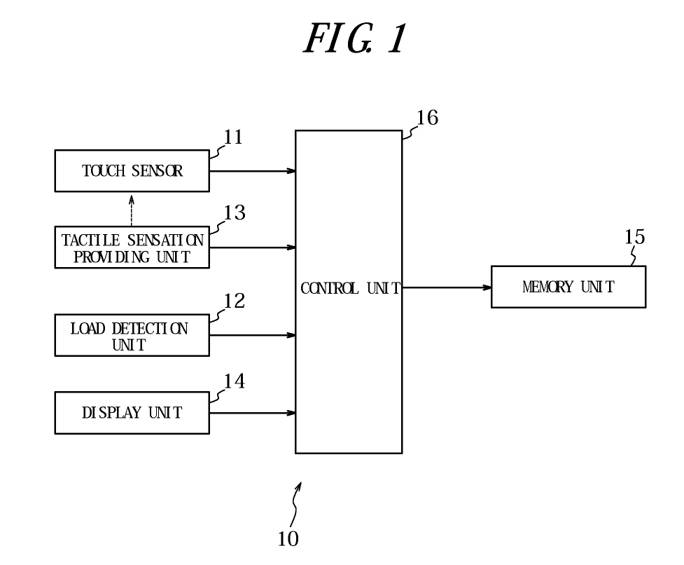

FIG. 1 is a functional block diagram schematically illustrating an internal configuration of a mobile phone 10 according to the present embodiment of the invention. As illustrated in FIG. 1, the mobile phone 10 has a touch sensor 11, a load detection unit 12, a tactile sensation providing unit 13, a display unit 14, a memory unit 15, and a control unit 16 to control overall operations.

The touch sensor 11, disposed on the display unit 14, detects a touch input to a touch face by a touch object such as a finger and the like and may be of a known type, such as a resistive film type, a capacitive type, an optical type and the like to output two-dimensional position information of a touch position. In order for the touch sensor 11 to detect the touch input, it is not necessary for the touch object to physically touch (contact) the touch sensor 11. For example, when the touch sensor 11 is of the optical type, the touch sensor 11 detects a position where an infrared ray on the touch sensor 11 is blocked by the touch object. Accordingly, the touch object does not need to directly touch the touch sensor 11. The load detection unit 12 detects a pressure load on the touch face of the touch sensor 11 and is configured by using, for example, a strain gauge sensor, a piezoelectric element and the like. The tactile sensation providing unit 13 vibrates the touch sensor 11 and is configured by, for example, a piezoelectric element.

The display unit 14 displays an input object such as an input button, an icon or the like of a push-button switch (push-type button switch) and may be constituted by using, for example, a liquid crystal display panel, an organic EL display panel or the like.

The control unit 16 determines whether the touch input to the display unit 14 by the touch object is the touch input to the input object, based on position information output from the touch sensor 11. When the touch input is to the input object and satisfies another predetermined condition (for example, the pressure load detected by the load detection unit 12 satisfies a predetermined standard load), the control unit 16 executes processing corresponding to the input object to which the touch input is performed, as described below. The memory unit 15 stores various applications and a variety of input information, as well as functioning as a work memory. The control unit 16 may be, for example, a CPU and the like and controls an operation of each unit based on the position information from the touch sensor 11, pressure load information from the load detection unit 12 and the like.

The mobile phone 10 further includes a variety of function units necessary for providing functions as a normal mobile phone, such as an antenna and a radio communication unit for transmitting and receiving various information such as voice and email with a base station via the internet, radio communication and the like. However, these various function units, having no particular distinction from those of known arts, are not illustrated in the figures, and descriptions thereof are omitted.

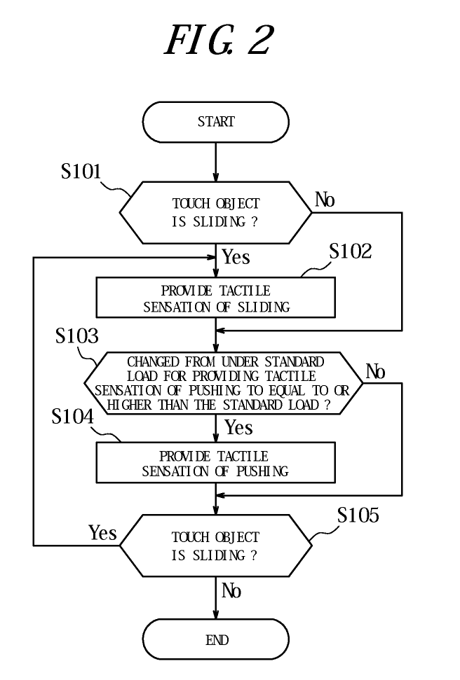

FIG. 2 is a flowchart for illustrating a process to provide a tactile sensation of sliding and a tactile sensation of pushing according to a first embodiment. The process starts when the touch sensor 11 detects the touch input to the touch face by the touch object such as the finger, a stylus pen and the like.

After the touch sensor 11 detects the touch input, the control unit 16 determines whether the touch object is sliding on the touch face (step S101). When the position information output from the touch sensor 11 is continuously changing for a predetermined distance or longer at step S101, the control unit 16 determines that the touch object is sliding on the touch face.

When the control unit 16 determines at step S 101 that the touch object is sliding on the touch face, the control unit 16 controls drive of the tactile sensation providing unit 13 such that the tactile sensation of sliding is provided to the touch object (step S102). After step S102, the control unit 16 determines whether the load detection unit 12 has detected the pressure load changing from a state failing to satisfy the standard load (predetermined standard load) for providing the tactile sensation of pushing to a state satisfying the standard load (hereinafter, this step is described in the figure as “changed from under standard load for providing tactile sensation of pushing to equal to or higher than the standard load?”) (step S103).

When the load detection unit 12 detects the pressure load changing from the state failing to satisfy the standard load for providing the tactile sensation of pushing to the state satisfying it at step S103, the control unit 16 controls drive of the tactile sensation providing unit 13 such that the tactile sensation of pushing is provided to the touch object (step S104). After step S104, or at step S103, when the load detection unit 12 does not detect the pressure load changing from the state failing to satisfy the standard load for providing the tactile sensation of pushing to the state satisfying it, the control unit 16 determines whether the touch object is sliding on the touch face (step S105). When the control unit 16 determines that the touch object is sliding at step S105, the process proceeds to step S102, whereas the process ends when the control unit 16 determines that the touch object is not sliding.

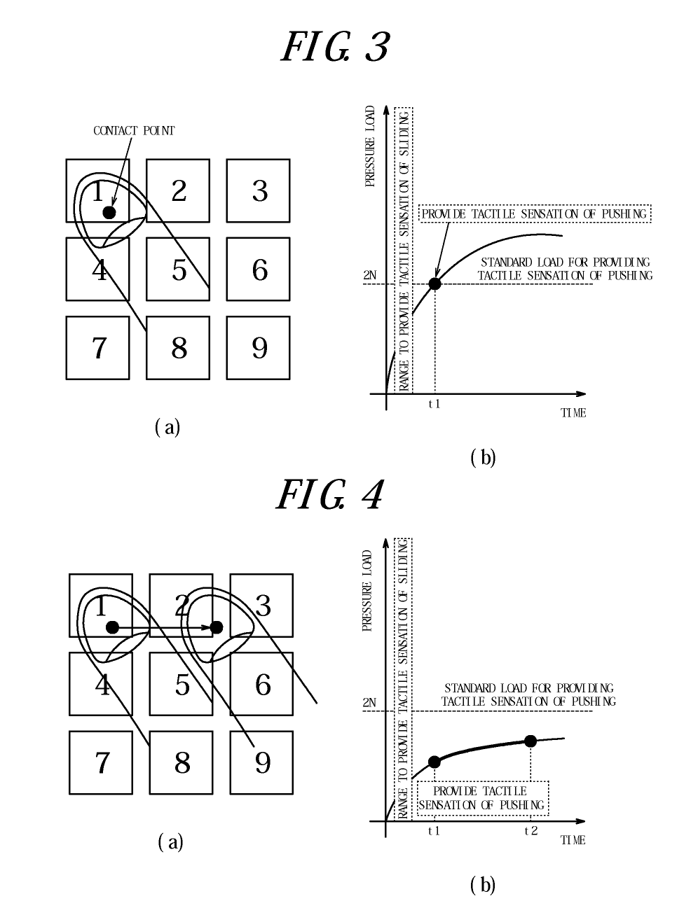

Next, FIG. 3 illustrates diagrams illustrating provision of the tactile sensation of pushing according to the first embodiment.

FIG. 3(a) illustrates buttons “1” to “9” as the input objects displayed on the display unit 14 and the finger as the touch object. The touch sensor 11 (not illustrated) is disposed on the display unit 14. The touch sensor 11 detects the touch input to the display unit 14 and outputs the position information of the touch input to the control unit 16. In FIG. 3(a), the touch object is performing the touch input to the input object, the button “1”.

In a graph illustrated in FIG. 3(b), a horizontal axis and a vertical axis represent time and the pressure load on the touch face detected by the load detection unit 12, respectively. According to the first embodiment, the standard load for providing the tactile sensation of pushing is set to be 2 N. When the load detection unit 12 detects the pressure load changing from a state failing to satisfy 2 N to a state satisfying it, the control unit 16 controls drive of the tactile sensation providing unit 13 such that the tactile sensation of pushing is provided to the touch object.

Here, provision of the tactile sensation of pushing, different from the tactile sensation of sliding, allows the user to clearly recognize that a push operation is received. In order to differentiate the tactile sensation of pushing and the tactile sensation of sliding, the control unit 16 drives the tactile sensation providing unit 13 with, for example, different frequencies, periods (times), amplitude or waveforms. In order to provide the tactile sensation of pushing, it is preferable that, when the load detection unit 12 detects the pressure load at 2 N, the control unit 16 controls drive of the tactile sensation providing unit 13 with a sine wave with a frequency of approximately 170 Hz for 1 period for vibrating in amplitude of 15 or more. Thereby, the touch object is provided with the tactile sensation similar to that obtained when pushing the push-button switch.

Next, FIG. 4 illustrates diagrams illustrating provision of the tactile sensation of sliding according to the first embodiment.

In the similar manner to FIG. 3(a), FIG. 4(a) illustrates buttons “1” to “9” as the input objects displayed on the display unit 14 and the finger as the touch object. In FIG. 4(a), the touch object is sliding to the right from the button “1”.

Next, in the similar manner to FIG. 3(b), FIG. 4(b) is a diagram illustrating a relationship between the time and the pressure load on the touch face detected by the load detection unit 12. In FIG. 4(b), a bold part of a line from a time t1 to a time t2 indicates that the touch object slides from the time t1 to the time t2. When the touch object slides, the control unit 16 controls drive of the tactile sensation providing unit 13 such that the tactile sensation of sliding is provided to the touch object.

According to the first embodiment, as described above, when the touch object slides on the touch face, the control unit 16 controls drive of the tactile sensation providing unit 13 such that the tactile sensation of sliding is provided to the touch object. In addition, when the load detection unit 12 detects the pressure load changing from the state failing to satisfy the standard load for providing the tactile sensation of pushing to the state satisfying it, the control unit 16 controls drive of the tactile sensation providing unit 13 such that the tactile sensation of pushing is provided to the touch object. Thereby, it is possible to provide the user with feedback through the tactile sensation in response to the push operation and the slide operation to the touch sensor 11 by the user.

### Second Embodiment

Next, processing to provide the tactile sensation of sliding and the tactile sensation of pushing according to a second embodiment of the present invention will be described.

According to the second embodiment, a condition to provide the tactile sensation of sliding and that to provide the tactile sensation of pushing to the touch object according to the first embodiment set forth above are differentiated more clearly.

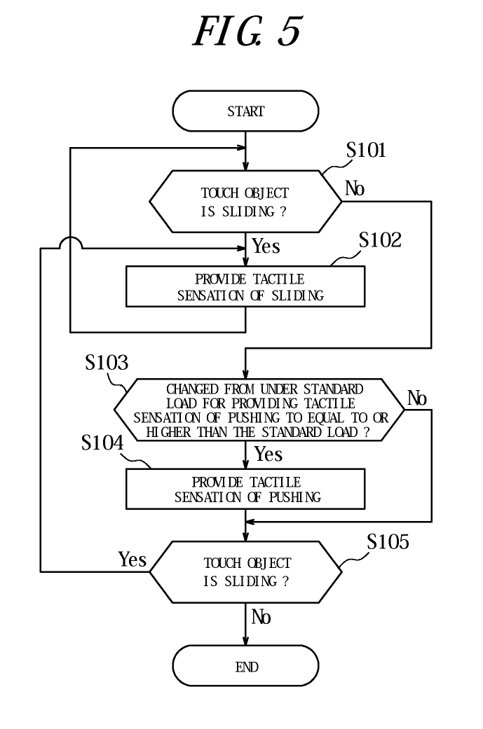

FIG. 5 is a flowchart for illustrating a process to provide the tactile sensation of sliding and the tactile sensation of pushing according to the second embodiment. In the flowchart illustrated in FIG. 5, steps for the same operations as those in the flowchart in FIG. 2 according to the first embodiment are provided with the same step numbers, and descriptions thereof are omitted.

In the flowchart according to the second embodiment, the operation at each step is the same as that in the flowchart according to the first embodiment, except for shifting back to step S101 after step S102. According to the second embodiment, when the touch object is not sliding on the touch face at step S101, the process shifts to step S103.

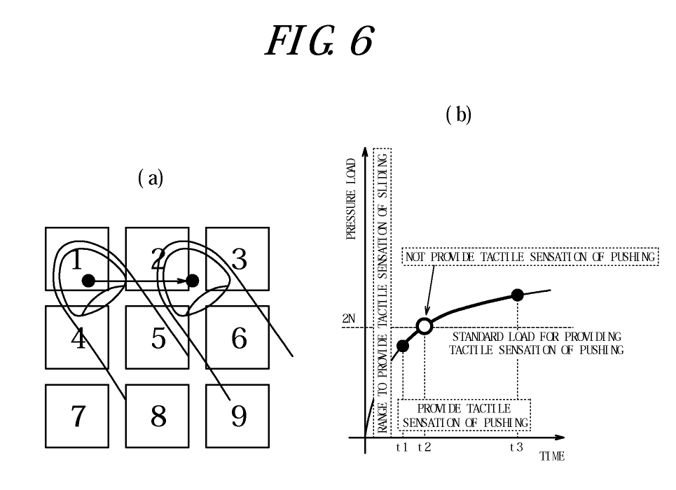

Next, FIG. 6 illustrates diagrams illustrating provision of the tactile sensation of sliding according to the second embodiment. Since FIG. 6(a) is the same as FIG. 4(a), a description thereof is omitted.

FIG. 6(b) is a diagram illustrating the relationship between the time and the pressure load on the touch face detected by the load detection unit 12. Here, the description overlapping FIG. 4(b) is omitted. In FIG. 6(b), the touch object slides from the time t1 to a time t3 and, in accordance with slide of the touch object, the control unit 16 controls drive of the tactile sensation providing unit 13 such that the tactile sensation of sliding is provided to the touch object from the time t1 to the time t3. Here, although the load detection unit 12 detects the pressure load changing from the state satisfying the standard load for providing the tactile sensation of pushing to the state failing to satisfy it at the time t2, the control unit 16 controls drive of the tactile sensation providing unit 13 such that the tactile sensation of sliding is provided to the touch object without providing the tactile sensation of pushing.

According to the second embodiment, as described above, when the load detection unit 12 detects the pressure load changing from the state failing to satisfy the standard load for providing the tactile sensation of pushing to the state satisfying it while the touch object is not sliding on the touch face, the control unit 16 controls drive of the tactile sensation providing unit 13 such that the tactile sensation of pushing is provided to the touch object. In addition, when the load detection unit 12 detects the pressure load changing from the state failing to satisfy the standard load for providing the tactile sensation of pushing to the state satisfying it while the touch object is sliding on the touch face, the control unit 16 does not control drive of the tactile sensation providing unit 13, such that the tactile sensation of pushing is not provided to the touch object. Accordingly, when the user is carrying out a slide operation to the touch sensor 11, the tactile sensation of sliding is provided to the user without the tactile sensation of pushing. Therefore, a feeling of strangeness is not inflicted on the user in slide operation.

### Third Embodiment

Next, processing to provide the tactile sensation of sliding and the tactile sensation of pushing according to a third embodiment of the present invention will be described.

According to the third embodiment, a standard load for providing the tactile sensation of sliding is set lower than the standard load for providing the tactile sensation of pushing (a standard load lower than the predetermined standard load is set) according to the second embodiment set forth above.

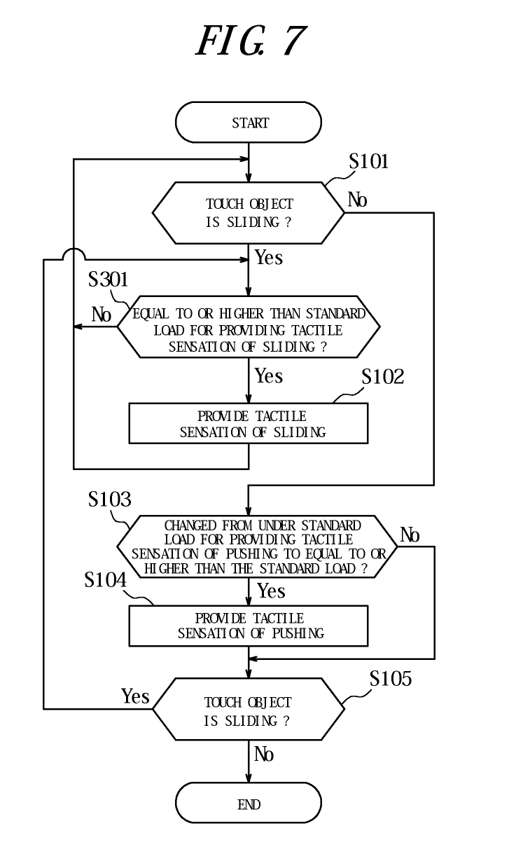

FIG. 7 is a flowchart for illustrating a process to provide the tactile sensation of sliding and the tactile sensation of pushing according to the third embodiment. In the flowchart illustrated in FIG. 7, steps for the same operations as those in the flowchart in FIG. 5 according to the second embodiment are provided with the same step numbers, and descriptions thereof are omitted.

In the flowchart according to the third embodiment, step S301 is newly provided between step S101 and step S102 in the flowchart according to the second embodiment. At step S301, the control unit 16 determines whether the pressure load detected by the load detection unit 12 satisfies the standard load for providing the tactile sensation of sliding (hereinafter, it is described in the figure as “equal to or higher than standard load for providing tactile sensation of sliding?”). When the control unit 16 determines at step S301 that the pressure load detected by the load detection unit 12 satisfies the standard load for providing the tactile sensation of sliding, the process shifts to step S102. On the other hand, when the control unit 16 determines that the pressure load detected by the load detection unit 12 fails to satisfy the standard load for providing the tactile sensation of sliding, the process returns to step S101.

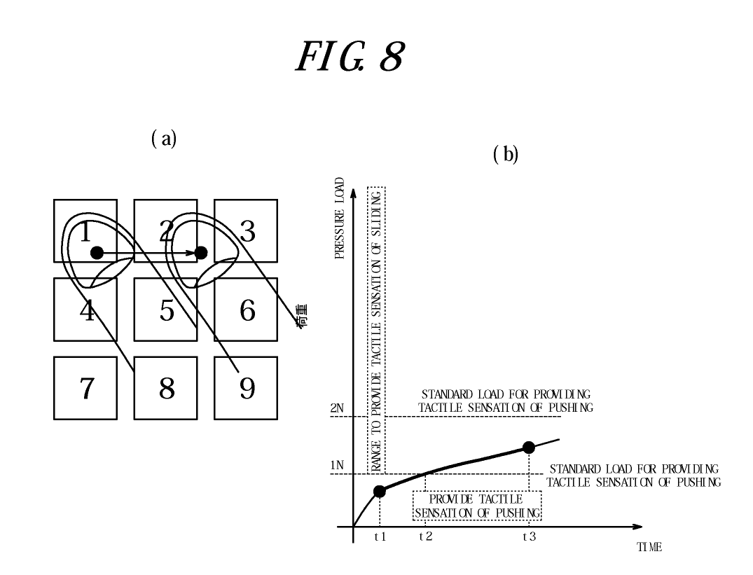

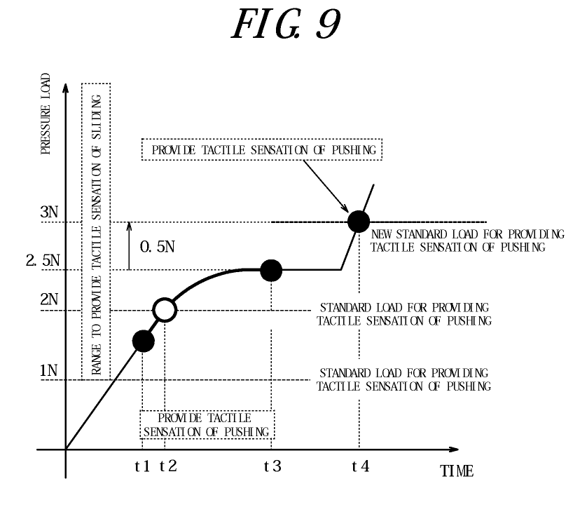

Next, FIG. 8 illustrates diagrams illustrating provision of the tactile sensation of sliding according to the third embodiment.

Since FIG. 8(a) is the same as FIG. 6(a), a description thereof is omitted.

FIG. 8(b) is a diagram illustrating the relationship between the time and the pressure load on the touch face detected by the load detection unit 12. Here, the same description as FIG. 6(b) is omitted. Compared with FIG. 6(b), FIG. 8(b) illustrates a standard load (1 N) newly set for providing the tactile sensation of sliding.

In FIG. 8(b), although the touch object slides from the time t1 to the time t3, the pressure load detected by the load detection unit 12 fails to satisfy the standard load for providing the tactile sensation of sliding from the time t1 to the time t2. Therefore, from the time t1 to the time t2, the control unit 16 does not control drive of the tactile sensation providing unit 13, such that the tactile sensation of sliding is not provided to the touch object. On the other hand, from the time t2 to the time t3, the touch object slides on the touch face and, simultaneously, the pressure load detected by the load detection unit 12 satisfies the standard load for providing the tactile sensation of sliding. Therefore, the control unit 16 controls drive of the tactile sensation providing unit 13 such that the tactile sensation of sliding is provided to the touch object.

According to the third embodiment, as described above, even when the touch object slides on the touch face, the control unit 16 does not control drive of the tactile sensation providing unit 13 to provide the tactile sensation of sliding to the touch object if the pressure load detected by the load detection unit 12 fails to satisfy the standard load for providing the tactile sensation of sliding. Accordingly, even when the user inadvertently touches the touch sensor 11 with the finger and slides the finger on the touch face, the tactile sensation of sliding is not provided to the touch object unless the pressure load detected by the load detection unit 12 satisfies the standard load for providing the tactile sensation of sliding. It is thus possible to avoid a process such as to provide the tactile sensation of sliding in response to the slide operation unintended by the user.

### Fourth Embodiment

Next, processing to provide the tactile sensation of sliding and the tactile sensation of pushing according to a fourth embodiment of the present invention will be described.

According to the fourth embodiment, the standard load for providing the tactile sensation of pushing according to the third embodiment set forth above is appropriately changed. The standard load for providing the tactile sensation of pushing is predetermined to be 2 N according to the third embodiment. The standard load for providing the tactile sensation of pushing according to the fourth embodiment is set on the basis of the pressure load detected by the load detection unit 12 when slide of the touch object is finished after being detected.

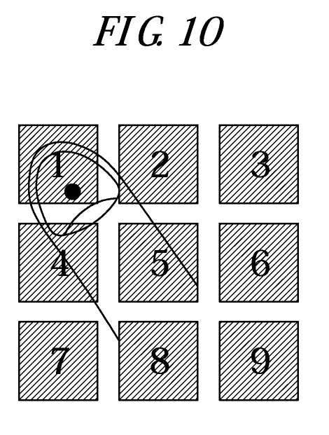

FIG. 9 is a diagram illustrating processing to provide the tactile sensation of sliding and the tactile sensation of pushing according to the fourth embodiment.

FIG. 9 illustrates the relationship between the time and the pressure load on the touch face detected by the load detection unit 12. Here, the descriptions overlapping FIG. 8(b) are omitted. According to the fourth embodiment, the standard load for providing the tactile sensation of sliding is preset to be 1 N and the standard load for providing the tactile sensation of pushing is preset to be 2 N.

In FIG. 9, the touch object slides from the time t1 to the time t3. When the touch object slides on the touch face, the control unit 16 controls drive of the tactile sensation providing unit 13 such that the tactile sensation of sliding is provided to the touch object. Here, at the time t2, the load detection unit 12 detects the pressure load changing from the state failing to satisfy the standard load for providing the tactile sensation of pushing to the state satisfying it. However, the control unit 16 controls drive of the tactile sensation providing unit 13 such that the tactile sensation of sliding is provided to the touch object without providing the tactile sensation of pushing. In addition, at the time t3, which is when the touch object finishes sliding, the control unit 16 sets a new standard load for providing the tactile sensation of pushing, on the basis of the pressure load detected by the load detection unit 12.

Here, as illustrated in FIG. 9, the new standard load for providing the tactile sensation of pushing is set to be 3 N, by adding 0.5 N to 2.5 N, which is the pressure load detected by the load detection unit 12 at the time t3. After setting the new standard load for providing the tactile sensation of pushing, when the pressure load detected by the load detection unit 12 changes from a state failing to satisfy the new standard load for providing the tactile sensation of pushing to a state satisfying it (time t4), the control unit 16 controls drive of the tactile sensation providing unit 13 such that the tactile sensation of pushing is provided to the touch object.

According to the fourth embodiment, as described above, the new standard load for providing the tactile sensation of pushing is set on the basis of the pressure load detected by the load detection unit 12 when the touch object finishes sliding. Accordingly, when the user carries out the slide operation to the touch sensor 11 and, subsequently, the push operation without removing the finger from the touch sensor 11, the tactile sensation for the push operation is reliably provided. It is thus possible to unfailingly provide feedback through the tactile sensation in response to the slide operation and the push operation by the user.

### Fifth Embodiment

Next, a process to provide the tactile sensation of sliding and the tactile sensation of pushing according to a fifth embodiment will be described.

According to the fifth embodiment, whether to provide the tactile sensation of pushing or whether to provide the tactile sensation of sliding according to the first embodiment set forth above are determined based on whether the touch object performs the touch input to the input object displayed on the display unit 14.

FIG. 10 is a diagram illustrating provision of the tactile sensation of pushing according to the fifth embodiment.

FIG. 10 illustrates the buttons “1” to “9” as the input objects displayed on the display unit 14 and the finger as the touch object. According to the fifth embodiment, when the touch input is performed to hatched input objects in FIG. 10, and, the pressure load detected by the load detection unit 12 changes from the state failing to satisfy the standard load for providing the tactile sensation of pushing to the state satisfying it, the control unit 16 controls drive of the tactile sensation providing unit 13 such that the tactile sensation of pushing is provided to the touch object. On the other hand, when the touch input is performed to an area not displaying the hatched input objects in FIG. 10, the control unit 16 does not control drive of the tactile sensation providing unit 13, such that the tactile sensation of pushing is not provided to the touch object, even if the pressure load detected by the load detection unit 12 changes from the state failing to satisfy the standard load for providing the tactile sensation of pushing to the state satisfying it.

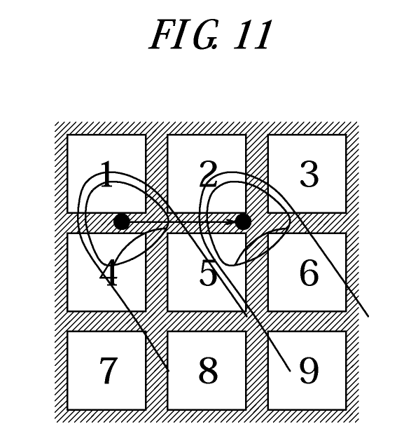

Next, FIG. 11 is a diagram illustrating provision of the tactile sensation of sliding according to the fifth embodiment.

FIG. 11 illustrates the buttons “1” to “9” as the input objects displayed on the display unit 14 and the finger as the touch object. The area having no input objects is hatched. According to the fifth embodiment, when the touch input is performed to the hatched area displaying no input objects in FIG. 11 and, in addition, the touch object slides on the touch face, the control unit 16 controls drive of the tactile sensation providing unit 13 such that the tactile sensation of sliding is provided to the touch object. On the other hand, when the touch input is performed to an area displaying the input object, the control unit 16 does not control drive of the tactile sensation providing unit 13, such that the tactile sensation of sliding is not provided to the touch object, even if the touch object slides on the touch face.

According to the fifth embodiment, accordingly, it is determined whether the touch input is performed to the input object displayed on the display unit 14 and, based on the determination, the tactile sensation of sliding and the tactile sensation of pushing are provided. Since the tactile sensation corresponding to the input object is provided to the user, it allows the user, through the tactile sensation, to determine whether the touch input is performed to the input object or the area intended by the user and the slide operation or the push operation intended by the user is received.

Although the present invention is described based on figures and the embodiments, it is to be understood that those who are ordinarily skilled in the art may easily vary or alter in a multiple manner based on disclosure of the present invention. Accordingly, such variation and modification are included in a scope of the present invention.

According to the third and fourth embodiments, when the touch object slides on the touch face while the pressure load detected by the load detection unit 12 satisfies the standard to provide the tactile sensation of sliding, the control unit 16 controls drive of the tactile sensation providing unit 13 such that the tactile sensation of sliding is provided to the touch object. However, it is also possible that, even when the pressure load detected by the load detection unit 12 stops satisfying the standard load for providing the tactile sensation of sliding after the control unit 16 controls drive of the tactile sensation providing unit 13 such that the tactile sensation of sliding is provided to the touch object, the control unit 16 controls drive of the tactile sensation providing unit 13 such that the tactile sensation of sliding is provided to the touch object while the touch object keeps sliding on the touch face.

According to the embodiments of the present invention, although the tactile sensation providing unit 13 and the load detection unit 12 are individually constituted, it is also possible to substantialize them with the same element. To that end, a piezoelectric element is preferably used, for example. Incidentally, according to the embodiments of the present invention, the control unit 16 determines that the touch object is sliding on the touch face when the position information output from the touch sensor 11 continuously changes for the predetermined distance or longer. However, a method to determine whether the touch object is sliding on the touch face is not limited to the method described above but a known slide detection method may be used.

According to the embodiments of the present invention, moreover, when the load detection unit 12 detects the pressure load changing from the state failing to satisfy the standard load for providing the tactile sensation of pushing to the state satisfying it, the control unit 16 controls drive of the tactile sensation providing unit 13 such that the tactile sensation of pushing is provided to the touch object. However, if the touch input is performed to the input object when the load detection unit 12 detects the pressure load changing from the state failing to satisfy the standard load for providing the tactile sensation of pushing to the state satisfying it, the control unit 16 may control such that the tactile sensation of pushing is provided and also processing corresponding to the input object is executed.

According to the fifth embodiment, further, when the touch input is performed to the area not illustrating the input object and, in addition, the touch object slides on the touch face, the control unit 16 controls drive of the tactile sensation providing unit 13 such that the tactile sensation of sliding is provided to the touch object. However, it is also possible that the control unit 16 controls drive of the tactile sensation providing unit 13 such that different tactile sensations of sliding are provided for the area having the input object displayed and for the area without the input objects.

### REFERENCE SIGNS LIST

10 mobile phone
11 touch sensor
12 load detection unit
13 tactile sensation providing unit
14 display unit
15 memory unit
16 control unit

1. An input apparatus comprising:
a touch sensor configured to detect a touch input;
a tactile sensation providing unit configured to vibrate a touch face of the touch sensor;
a load detection unit configured to detect a pressure load on the touch face; and
a control unit configured to control drive of the tactile sensation providing unit such that a tactile sensation is provided to a touch object touching the touch face,
wherein
the control unit, when the touch object is sliding on the touch face, controls drive of the tactile sensation providing unit such that a tactile sensation of sliding is provided to the touch object and, when the load detection unit detects the pressure load changing from a state failing to satisfy a predetermined standard load to a state satisfying the predetermined standard load, controls drive of the tactile sensation providing unit such that a tactile sensation of pushing, different from the tactile sensation of sliding, is provided to the touch object.

2. The input apparatus according to claim 1, wherein the control unit controls drive of the tactile sensation providing unit such that the tactile sensation of pushing is provided to the touch object when the touch object is not sliding on the touch face.

3. The input apparatus according to claim 1 or 2, wherein the control unit controls drive of the tactile sensation providing unit such that the tactile sensation of sliding is provided to the touch object when the pressure load detected by the load detection unit satisfies a standard load lower than the predetermined standard load.

4. The input apparatus according to any one of claims 1 to 3, wherein, when the touch object stops sliding while the control unit is controlling drive of the tactile sensation providing unit such that the tactile sensation of sliding is provided to the touch object, and the load detection unit detects application of a predetermined pressure load in addition to a standard, which is the pressure load detected by the load detection unit when the touch object stops sliding, the control unit controls drive of the tactile sensation providing unit such that the tactile sensation of pushing is provided to the touch object.

5. The input apparatus according to any one of claims 1 to 4, further comprising a display unit configured to display an input object, wherein
the touch sensor detects the touch input to the display unit, and
the control unit controls drive of the tactile sensation providing unit, when the touch input to an area, where the input object is not displayed, is detected, such that the tactile sensation of sliding is provided, and controls drive of the tactile sensation providing unit, when the touch input to the input object is detected, such that the tactile sensation of pushing is provided.
